(19) United States
(12) Patent Application Publication
(10) Pub. No.: US 2007/0214226 A1
(43) Pub. Date: Sep. 13, 2007

(54) Method and system for pushing electronic mail

(75) Inventors: Yu Song, Pleasanton, CA (US); Doreen Cheng, San Jose, CA (US); Alan Messer, Los Gatos, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/713,349

(22) Filed: Mar. 1, 2007

Related U.S. Application Data
(60) Provisional application No. 60/780,401, filed on Mar. 7, 2006.

(51) Int. Cl. G06F 15/16

(52) U.S. Cl. 709/206

(57) ABSTRACT

A method and system for delivering emails is provided, wherein emails are pushed from an email server to an email client without polling. Emails are delivered to the email client directly by pushing, without requiring the email client to poll an email server periodically.

### RELATED APPLICATION

This application claims priority from U.S. Provisional Patent Application Ser. No. 60/780,401 filed on Mar. 7, 2006, incorporated herein by reference.

### FIELD OF THE INVENTION

The present invention relates to electronic mail (email) delivery in communication systems

### BACKGROUND OF THE INVENTION

Email has become an important part of electronic communications over networks, such as the Internet. In the Internet context, the delivery of email has two distinguishable aspects. The first aspect of email delivery involves the Simple Mail Transfer Protocol (SMTP) to send emails from a personal device to a source email server and from a source email server to a destination email server. The second aspect of email delivery involves receiving emails from an email server on a personal device. This is accomplished via the Post Office Protocol 3 (POP3) and Internet Message Access Protocol (IMAP). Both protocols require a personal device to periodically poll an email server for newly arrived emails. For example, popular email clients, such as Microsoft Outlook, Mozilla Thunderbird, contain both POP3 client and IMAP client to poll emails from POP3 servers and IMAP servers, respectively. During configuration of an email client in the personal device, a user can specify how often the polling occurs.

Polling has several disadvantages however. First, polling increases traffic on the Internet. As more users utilize the Internet for email, and as email becomes a part of their communication tools, potentially, billions of email polling requests is sent every few seconds or minutes. Second, polling increases system resource usage on the email receiver. Small devices are increasingly becoming capable of interconnection, and users utilize such devices for email communication. Periodically, the small device must establish a connection to an email server, and request newly arrived emails. If a user has several email accounts with different email servers, an email client in the small device has to poll those email servers one after another. This increases the resource usage on the small devices, and consumes battery power.

Third, polling places a heavy load on an email server, whereby an email server must be prepared to handle potentially large numbers of email client requests simultaneously and/or in a short period of time. There is, therefore, a need for a method and system for providing electronic mail rather than polling.

### BRIEF SUMMARY OF THE INVENTION

The present invention provides a method and system for pushing email by delivering emails from an email server to an email client in a client device, such as a personal electronic device directly, without polling. The present invention enables pushing email messages to the client device directly instead of requiring the client device to poll an email server periodically.

In one embodiment, the present invention provides a system that implements a method for email communication, the system comprising: an email server including an email relay module and an email registration module, wherein the email registration module registers the final destination of an email, and the email relay module relays each email received by the email server to the final destination for the email; an email client that registers itself with the email registration module of the email server; wherein when the email server receives an email that is intended for the registered email client as the final destination of that email, the email relay module of the email server relays the email to the email client, whereby the email is delivered to the email client by pushing the email directly to the email client without the email client polling for the email.

Preferably, the system further comprises a gateway, including an email relay module and an email registration module, wherein the email registration module of the gateway registers the final destination of an email, and the email relay module of the gateway relays an email to its final destination; wherein the email client further registers itself with the email registration module of the gateway; wherein when the email server receives an email that is intended for the registered email client as the final destination of that email, the email relay module of the email server relays the email to the email relay module of the gateway, and the email relay module of the gateway relays the email to the email client, whereby the email is delivered to the email client by pushing the email directly without the email client polling for the email.

The present invention further provides a system including an email server on the Internet, two local area networks and an email client in a client device. Each local area network includes a gateway. Each gateway includes an email relay module and an email registration module. When the client module is part of the first local area network, the client device registers with the first gateway. The client device also registers with the server on the Internet. Thereafter, when the client device moves to the second local area network, the client device registers with the second gateway. The client device also sends a registration message to the first gateway about its new location. Thereafter, when an email arrives at the email server designated to the client device, the email server relays the email to the first gateway, the relay module of the first gateway relays the email to the second gateway, and the relay module of the second gateway forwards it to the client device.

These and other features, aspects and advantages of the present invention will become understood with reference to the following description, appended claims and accompanying figures.

### BRIEF DESCRIPTION OF THE DRAWINGS

FIG. 1 shows a functional block diagram of a system for pushing emails according to an embodiment of the present invention.

FIG. 2 shows a flowchart of the steps of pushing emails in the system of FIG. 1, according to an embodiment of the present invention.

FIG. 3 shows another functional block diagram of a system for pushing emails to an email client which has moved from a first local area network to a second local area network, according to another embodiment of the present invention.

FIG. 4 shows a flowchart of the steps of pushing emails in the system of FIG. 3, according to an embodiment of the present invention.

### DETAILED DESCRIPTION OF THE INVENTION

The present invention provides a method and system for pushing emails from an email server to an email client in a client device such as personal electronic devices directly, without requiring the email client to poll the email server periodically.

In one embodiment, pushing emails according to the present invention involves first registering an email client with a gateway in a local area network (LAN) to which the email client connects. The email client is also registered with an email server on an external network, which is the Internet in this example. The email client comprises a small email server that listens in on a SMTP port for any incoming message, and can notify a user when a message arrives. The gateway includes an edge router that separates a private network such as a LAN from the external network.

The email server in the external network includes an email relay module and an email registration module, wherein the email registration module registers the final destination of an email, and the email relay module relays each email received by the email server to the final destination for the email. As such, the email client registers itself with the email registration module of the email server.

When the email server receives an email that is intended for the registered email client as the final destination of that email, the email relay module of the email server relays the email to the email client, whereby the email is delivered to the email client by pushing the email directly to the email client without the email client polling for the email.

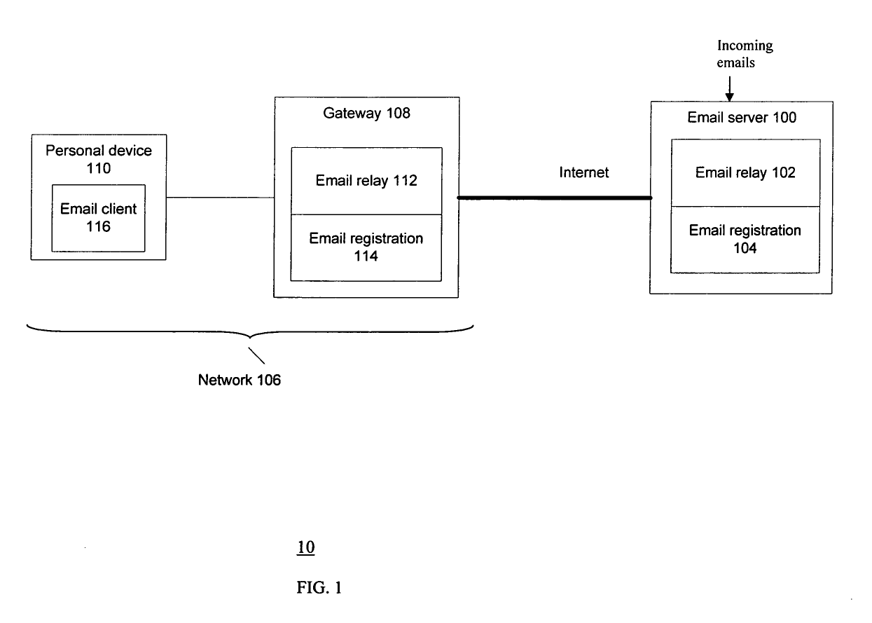

Referring to the drawings, an example implementation of the present invention is now described. FIG. 1 shows a functional block diagram of an example system 10 for pushing emails according to the present invention. An email server 100, such as Yahoo! mail server, resides on the Internet as an external network. The email server 100 includes an email relay module 102 and an email registration module 104. The email relay module 102 relays emails that the email server 100 receives (incoming emails), to the final destination of the email, such as an email client in a client device 110 in a private network 106, such as a LAN. The email registration module 104 registers a final destination for the email.

The private network 106 further includes a gateway 108 comprising an email relay module 112 and an email registration module 114. The email relay module 112 relays an email to its final destination. The email registration module 114 registers an email's final destination. The gateway can be an enterprise gateway, a home gateway, etc. The gateway can have a firewall that blocks certain types of traffic in and out of the private network. The gateway may also comprise a Dynamic Host Configuration Protocol (DHCP) server that dynamically assigns private IP addresses to devices in the private network. The gateway itself can have a static IP address or a dynamic IP address that is assigned by its Internet Service Provider (ISP).

The client device 110 includes an email client 116 which registers itself with the email registration modules 104 and 114, such that an email from the email server 100 can be relayed to the email client 116 as the final destination of the email.

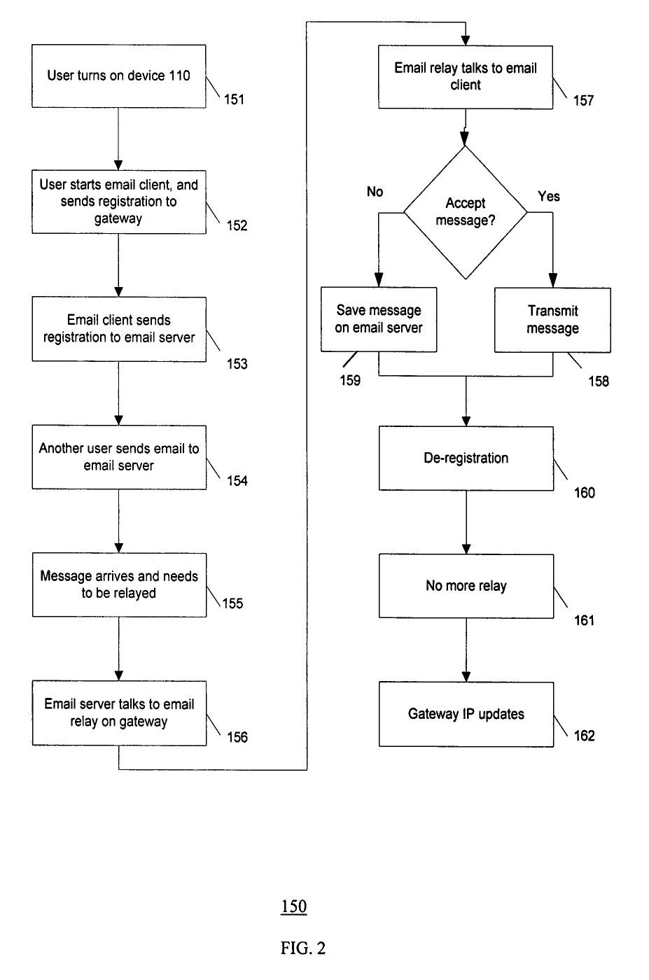

FIG. 2 shows a flowchart of a process 150 for pushing email in the system 10, according to an embodiment of the present invention, including the steps of:
Step 151: A user turns on the client device 110 in the private network 106. The client device 110 obtains an address in the private network (e.g., a private IP address either dynamically via a DHCP server or statically, etc.).
Step 152: The user starts the email client 116. When the email client 116 starts, it sends a registration message to the email registration module 114 with the user name of the email client 116 and the personal IP address. For example, email client 116 sends:
   “FORWARD FROM: <user@yahoo.com> TO <user@192.168.0.100>”
   where FROM shows an example of the user account on the email server 100, and TO shows an example of the user account on the client device 110 with a private IP address.
Step 153: After registration with the email registration module 114, the email client 116 registers with the email registration module 104 by sending information regarding the email relay module 112 and the email client 116. For example, the email client 116 sends:
   “FORWARD FROM: <user@yahoo.com> TO <user@144.29.105.5>”
   where FROM shows an example of the user account on the email server 100, and TO shows the public IP address of the gateway 108.
Step 154: Another user sends an email message to the user account on the email server 100.
Step 155: The message arrives on the email server 100. The email server 100 looks up its registration module 104 and finds where the message should be relayed to.
Step 156: The email relay module 102 starts to communicate with the email relay module 112 on the gateway 108 using the standard SMTP protocol.
Step 157: When the email relay module 112 receives a RCPT command from the email relay 102, and knows the final destination of the message is the client device 110, the email relay module 112 starts to communicate with the email client 116 on the client device 110 using the standard SMTP protocol. The RCPT command informs the mail server of the recipient of a message (it tells the mail server who the recipient of the message is).
Step 158: If the email client 116 accepts the RCPT command from the email relay 112, the email relay 112 also accepts the RCPT command from the email relay 102. Thereafter, the email message is transmitted from the email relay 102 to the email relay 112 to the email client 116. The acceptance criteria can include, e.g., a spam filtering list and personal preference, and a user may specify that she would not accept email on certain devices.
Step 159: Otherwise, the email client 116 rejects the RCPT command from the email relay 112, and causes the email relay 112 to reject email relay 102. If that occurs, the email server 100 saves the email message on the email server 100. This message will be delivered when a new registration message comes in or can be accessed by a traditional email client using either the POP3 or IMAP.
Step 160: At a later time, when the user turns off the email client 116, the email client 116 sends a de-registration message to the email registration modules 114 and 104.
Step 161: After de-registration, the email relays 102 and 112 will not relay the message.
Step 162: If the IP address of the gateway 108 is dynamically assigned, when it is renewed with a new IP address, the email registration module 114 looks up the registration and renews the registration with the email registration module 104 with a new IP address. For example:
   FORWARD FROM: <user@yahoo.com> TO <user@144.29.105.5> RENEW <user@63.29.105.100>
   where TO contains the old forward path, and RENEW contains the new forward path.

A second embodiment of pushing emails according to the present invention involves an email server on an external network, and two private networks such as LANS, and an email client in a client device. Each LAN includes a gateway. Each gateway includes an email relay module and an email registration module. When the client module is part of the first LAN, the client device registers with the first gateway. The client device also registers with the server on the Internet. Thereafter, when the client device moves to the second LAN, the client device registers with the second gateway. The client device also sends a registration message to the first gateway about its new location. Thereafter, when an email arrives at the email server designated to the client device, the email server relays the email to the first gateway, the relay module of the first gateway relays the email to the second gateway, and the relay module of the second gateway forwards it to the client device.

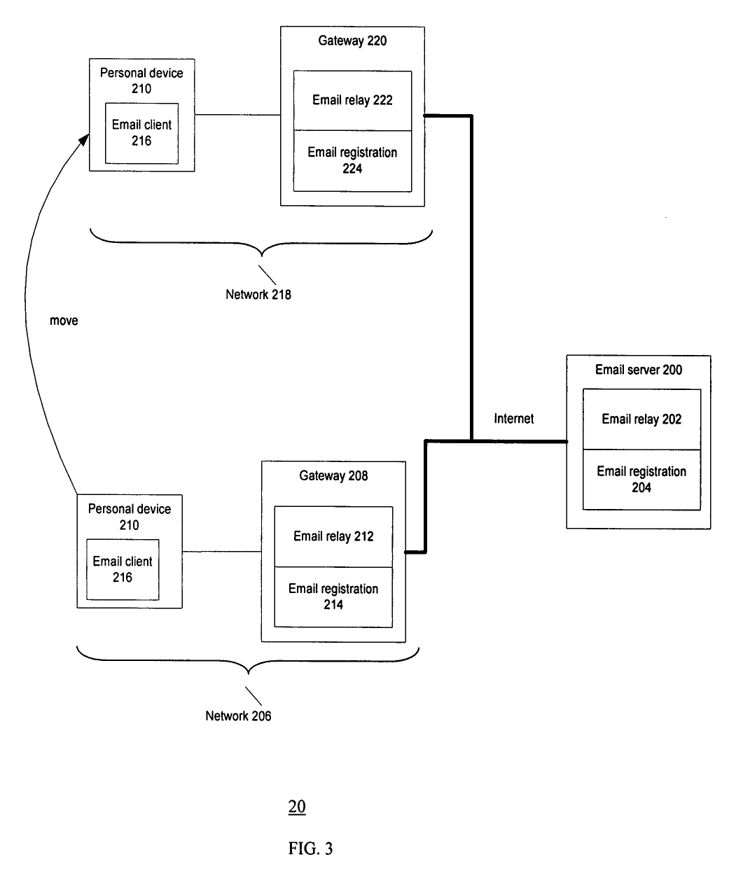

FIG. 3 shows a functional block diagram of a system 20 for pushing emails according to said second embodiment of the present invention. As an overview, the system involves an email server on the Internet, a client device's home gateway in a home LAN, and a foreign gateway in a foreign LAN that the client device can physically be moved to (shown in FIG. 3 by the curved arrow marked as “move”). In this example, registration with the email server only needs to occur once. Regardless of where the client device moves to, the email server always sends a message to the home gateway instead of sending a message to the foreign gateway where the client device is, and the home gateway will relay the email messages between the email server and the email client through the foreign gateway.

Specifically, an email server 200 includes an email relay module 202 and an email registration module 204. The email relay module 202 is to relay incoming/arrived messages to a forwarding destination. The email registration module 204 is used to register an email's forwarding destination.

A home (local/private) network 206 includes a home gateway 208 and a client device 210. The home gateway 208 is the default gateway for the client device 210. For example, a home device has a default gateway that is the gateway in a person's home; an office PC has a default gateway that is the office gateway, etc.

The home gateway 208 includes an email relay module 212 and an email registration module 214. The email relay module 212 is to relay an email message between the email server 200 and the client device 210 when the client device 210 is in the home network 206, or to relay an email message between the email server 200 and the foreign gateway 220 when the client device 210 is in the foreign network. The client device 210 registers its location with the email registration module 214.

The client device 210 includes an email client 216. The email client 216 is to receive an email message from the email server 200 and notify the user, for example, by popping up a little notification box. The foreign network 218 includes a foreign gateway 220. The foreign gateway 220 includes an email relay module 222 and an email registration module 224. The email relay module 222 is to relay an email message between the client device 210 and the gateway 208, if it is inside the foreign network 218, and the home gateway 208. The email registration module 224 is to allow the client device 210 to register with module 224 if the client device 210 is in the foreign network 218.

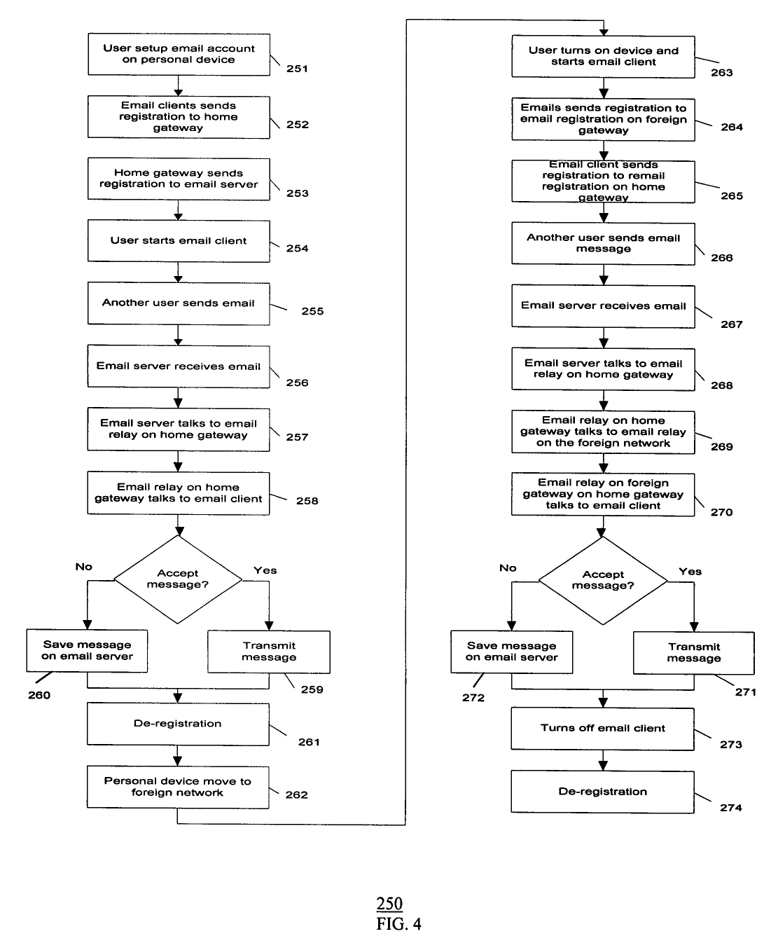

FIG. 4 shows a flowchart 250 of the steps of pushing emails in the system 20, according to another embodiment of the present invention, including the steps of:
Step 251: A user sets up an email account on the email client 216 on the client device 210 in the home network 206, by inputting the user account on the email server 200. The client device 210 also automatically detects the home gateway 208.
Step 252: During configuration, the email client 216 sends a registration message to the home gateway 208 with the email account on the email server 200. For example, the email client 216 sends:
   “FORWARD FROM: <user@yahoo.com> TO <user@192.168.0.100>”
   where FROM shows an example of the user account on the email server 200, and TO shows an example of the user account on the client device 210 with a private IP address.
Step 253: When the email registration module 214 of the gateway 208 receives a registration message, it sends the registration message to the email server 200 to let the email server 200 know that a message for the user should be forwarded to the home gateway 208. For example, the registration message can comprise:
   “FORWARD FROM: <user@yahoo.com> TO <user@105.144.29.88>”
   where FROM shows an example of the user account on the email server 200, and TO shows an example of the user account on the home gateway 208.
Step 254: At a later time, the user starts the email client 216 on the client device 210 and waits for any message to come in.
Step 255: Another user sends an email message to the user account on the email server 200.
Step 256: The message arrives on the email server 200. The email server 200 looks into its registration module 204 and finds the message should be relayed to the home gateway 208.
Step 257: The email relay module 202 starts to communicate with the email relay 212 on the home gateway 208 using the standard SMTP protocol.
Step 258: When the email relay module 212 receives the RCPT command from the email relay 202, and knows the final destination of the message is the client device 210, wherein the email relay module 212 starts communicating with the email client 216 on the client device 210 using the standard SMTP protocol.
Step 259: If the email client 216 accepts the RCPT command from the email relay 212, the email relay 212 also accepts the RCPT command from the email relay 202. Thereafter, the email message is transmitted from the email relay 202 to the email relay 204 to the email client 216.
Step 260: Otherwise, the email client 216 rejects the RCPT command from the email relay 212, and causes the email relay 212 to reject the email relay 202. In that case, the email server 200 saves the message on the email server 200. This message will be delivered when a new registration message comes in or can be accessed by a traditional email client using either the POP3 or IMAP.
Step 261: At a later time, when the user initiates turning off the email client 216, the email client 216 sends a de-registration message to the email registration module 214.
Step 262: The user carries the client device 210 to the foreign network 218.
Step 263: The user turns on the client device 210 and starts the email client 216.
Step 264: The email client 216 detects that it has a different private IP address, and the gateway private and public IP addresses change. Since the public IP address of the gateway 208 is usually different from that of the gateway 220, the email client 216 can infer that it has moved into a different network than its home network 206. The email client 216 sends a registration message to the foreign gateway 220. For example, the message can comprise:
   “FORWARD FROM: <user@105.144.29.88> TO: <user@172.124.0.100>”
   where FROM describes the home gateway public address, and TO is the user account on the email client 216 with a local private IP address in the foreign network 218. This tells the email relay that any email message from the home gateway 208 for the user should be forwarded to the email client 210.
Step 265: The email client 216 also sends a registration message to the home gateway 208 telling its current location. For example, the email client 216 sends:
   “FORWARD FROM: <user@yahoo.com> TO: <user@66.65.45.55>”
   which tells the home gateway 208 that any message from the email server 200 for the user should be forwarded to the foreign gateway 220.
Step 266: At a later time, another user sends an email message to the user account on the email server 200.
Step 267: The message arrives on the email server 200. The email server 200 looks into its registration module 204 and finds the message that should be relayed to the home gateway 208.
Step 268: The email relay module 202 starts to communicate with the email relay 212 on the home gateway 208 using the standard SMTP protocol.
Step 269: When the email relay module 212 receives the RCPT command from the email relay 202, and knows that the destination of the message is the foreign gateway 220, the email relay module 212 starts communicating with the email relay 222 on the foreign gateway 220 using the standard SMTP protocol.
Step 270: When the email relay module 222 receives the RCPT command from the email relay 212, and knows the final destination of the message is the email client 210. The email relay module 222 starts to talk to the email client 216 using the standard SMTP protocol.
Step 271: If the email client 216 accepts the RCPT command from the email relay 222, the email relay 222 also accepts the RCPT command from the email relay 212, which in turn, the email relay 212 also accepts the RCPT command from the email relay 202. After that the email message is transmitted from the email relay 202 to the email relay 212 to the email relay 222 and to the email client 216.
Step 272: Otherwise, the email client 216 rejects the RCPT command from the email relay 222, and causes the email relay 222 to reject the email relay 212, and the email relay 212 to reject the email 202. In that case, the email server 200 saves the message on the email server 200. This message will be delivered when a new registration message comes in or can be accessed by a traditional email client using either the POP3 or IMAP.
Step 273: This initiates turning off the email client 216.
Step 274: This causes the email client 216 to send a de-registration message to the foreign gateway 220 and the home gateway 208.

Pushing emails according to the present invention reduces traffic between a final destination email server and an email client. Pushing also allows faster delivery of email messages because email is pushed to the email client directly when it arrives on the email server. It also reduces resource usage on the client device, and on the email server.

As is known to those skilled in the art, the aforementioned example architectures described above, according to the present invention, can be implemented in many ways, such as program instructions for execution by a processor, as logic circuits, as an application specific integrated circuit, as firmware, etc.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of delivering electronic mail (email), comprising the steps of:
registering an email client with an email server for receiving emails;
receiving an email for the email client at the email server as the final destination of that email; and
relaying the received email from the email server to the email client by pushing the email to the email client.

2. The method of claim 1 wherein the step of registering with the email server further includes the step of registering the email client with an email registration module of the email server.

3. The method of claim 2 wherein the step of relaying the received email further includes the step of relaying the received email from a relay module of the email server to the email client.

4. The method of claim 3 wherein the email client is in a private network and the email server is on an external network.

5. The method of claim 4 wherein the private network includes a gateway and the method further comprising the steps of:
receiving an email from the email server at the gateway; and
relaying the received email to the email client from the gateway.

6. The method of claim 5 wherein the step of relaying the received email from the gateway further includes the step of relaying the received email to the email client from a relay module of the gateway.

7. The method of claim 6 further comprising the steps of:
registering the email client with a registration module of the gateway; and
relaying the received email to the email client from the relay module of the gateway.

8. The method of claim 4 wherein the private network further includes a client device and the email client resides in the client device.

9. The method of claim 8 wherein the private network comprises a LAN.

10. The method of claim 9 wherein the external network comprises the Internet and the email server resides on the Internet.

11. The method of claim 7 further comprising the steps:
the email client obtaining an address in the private network before registering with the registration modules;
the email client registering with the registration module of the gateway by sending the user name and email client address to that registration module;
the email client registering with the registration module of the email server by sending information about the relay module of the gateway and the email client to that registration module;
upon receiving an email, the email server utilizing its registration module to determine the relay destination for the email, and communicating with the email relay module of the gateway using the SMTP protocol;
upon receiving an initial email command from the email relay of the email server, the email relay module of the gateway utilizing its registration module to determine the email client as the final destination of the email, thereby communicating with the email client using a standard email transport protocol; and
upon the email client accepting an initial email command from the email relay module of the gateway, in turn the email relay module of the gateway accepting the initial email command from the email relay module of the email server, whereby the email is transmitted from the email relay module of the server to the email client via the email relay module of the gateway.

12. The method of claim 11 further comprising the step of:
detecting if the email client rejects the initial email command, and if so, then in turn the email relay module of the gateway rejecting the initial email command from the email relay module of the email server, whereby the email server saves the email for alternative delivery.

13. The method of claim 11 further comprising the step of the email client de-registering with the registration modules.

14. The method of claim 13 further comprising the step of the email client de-registering with the registration modules upon the email client shutting down and/or the client device turning off.

15. A system for delivering electronic mail (email), comprising:
an email server including a registration module configured to register the final destination of an email, and an email relay module configured to relay each email received by the email server to the final destination for the email; and
an email client configured to register itself with the email registration module of the email server;
wherein the email server is further configured to receive an email intended for the registered email client as the final destination of that email, and the email relay module is configured to relay the email to the email client by pushing the email directly to the email client.

16. The system of claim 15 further comprising a gateway including an email relay module and an email registration module, wherein the email registration module of the gateway is configured to register the final destination of an email, and the email relay module of the gateway is configured to relay an email to its final destination;
wherein the email client is further configured to register itself with the email registration module of the gateway; and
wherein when the email server is further configured to receive an email that is intended for the registered email client as the final destination of that email, the email relay module of the email server is further configured to relay the email to the email relay module of the gateway, and the email relay module of the gateway is further configured to relay the email to the email client, whereby the email is delivered to the email client by pushing the email directly to the email client.

17. The system of claim 15 wherein the email client is a component of a client device.

18. The system of claim 15 wherein the email client is a component of a private network, and the email server is a component of an external network.

19. The system of claim 18 wherein the external network comprises the Internet.

20. A system for electronic mail delivery, comprising:
an email server including an email relay module and an email registration module, wherein the email registration module is configured to register the forwarding destination of an email, and the email relay module is configured to relay each email received by the email server to the forwarding destination for that email;
an email client;
a first gateway, wherein the first gateway is the default gateway for the email client, the first gateway including an email relay module and an email registration module;
the email relay module of the first gateway is configured such that: upon detecting that the email client is connected to the first gateway, the email relay module of the first gateway relays an email between the email server and the email client, and upon detecting that the email client is connected to a foreign network, then the email relay module of the first gateway relays an email between the email server and the foreign gateway.

21. The system of claim 20 wherein:
the email client is configured to register its location with the email registration module of the first gateway;
the email registration module of the first gateway is configured to inform the registration module of the email server for forward emails intended for the email client to the first gateway;
the email server is further configured such that upon receiving an email, the email server utilizes its registration module to determine a relay destination for the email, and communicates with the email relay module of the first gateway using standard email transport protocol;
the email relay module of the first gateway is configured such that upon receiving an initial email command from the email relay of the email server, the email relay module of the first gateway utilizing its registration module to determine the email client as the final destination of the email, thereby communicating with the email client using standard email transport protocol; and
the email client is further configured to accept an initial email command from the email relay module of the first gateway, wherein the email relay module of the first gateway is further configured to accept the initial email command from the email relay module of the email server, whereby the email is transmitted from the email relay module of the server to the email client via the email relay module of the first gateway.

22. The system of claim 21 wherein:
the foreign gateway includes an email relay module and an email registration module, the email registration module of the foreign gateway is configured to allow the email device to register therewith, and the email relay module of the foreign gateway is configured to relay an email between the email client and the first gateway, such that the email client receives an email intended for the email client.

23. The system of claim 22 wherein:
the email client is further configured to register with the registration module of the foreign gateway;
the email client is further configured to inform the registration module of the first gateway of its location in a foreign network.

24. The system of claim 23 wherein:
upon receiving an email, the email server utilizes its registration module to determine the relay destination for the email, and communicates with the email relay module of the first gateway using a standard email transport protocol;
upon receiving an initial email command from the email relay of the email server, the email relay module of the first gateway utilizes its registration module to determine the email client as the final destination of the email, and communicates with the email relay module of the foreign gateway using a standard email transport protocol;
upon receiving an initial email command from the email relay of the first gateway, the email relay module of the foreign gateway utilizes its registration module to determine the email client as the final destination of the email, and thereby communicates with the email client using a standard email transport protocol; and
if the email client accepts an initial email command from the email relay module of the first gateway, in turn the email relay module of the foreign gateway accepts the initial email command from the email relay module of the first gateway, in turn the email relay module of the first gateway accepts the initial email command from the email relay module of the email server;
whereby the email is transmitted from the email relay module of the server to the email client via the email relay module of the first gateway and the email relay module of the foreign gateway.

25. The system of claim 24 wherein if the email client rejects the initial email command, then in turn the email relay modules of the foreign and first gateways reject the respective initial email commands, whereby the email server saves the email for alternative delivery.

26. The system of claim 24 wherein the email client de-registers with all of the registration modules.

27. The system of claim 24 wherein the email client de-registers with all of the registration modules, when the email client shuts down.
